(19) United States
(12) Patent Application Publication
(10) Pub. No.: US 2017/0116337 A1
(43) Pub. Date: Apr. 27, 2017

(54) USER INTEREST REMINDER NOTIFICATION

(71) Applicant: International Business Machines Corporation, Armonk, NY (US)

(72) Inventors: Thomas E. Creamer, Boca Raton, FL (US); Erik H. Katzen, Argyle, TX (US); Sumit Patel, Irving, TX (US)

(21) Appl. No.: 14/921,624

(22) Filed: Oct. 23, 2015

(51) Int. Cl. G06F 17/30; H04L 29/08

(52) U.S. Cl. CPC G06F 17/30867; G06F 17/30528; H04L 67/22; G06F 17/3087; G06F 17/30554

(57) ABSTRACT

User data generated by at least one client device used by a user can be monitored. Based on the user data, at least one item that is of interest to the user can be automatically determined. Activities of user can be tracked and, based on tracking the activities of the user, whether the user has free time available can be automatically determined. Responsive to determining that the user has free time available, a notification can be presented to the user via the at least one client device. The notification can indicate to the user the at least one item that is of interest to the user and the notification can further provide actionable information related to the at least one item that is of interest to the user.

### BACKGROUND

The present invention relates to electronic communications, and more specifically, to communication of prompts to users regarding items that may be of interest to the users.

Recommendation technology exists that attempts to predict items, such as movies, music and books, in which a user may be interested. Such prediction usually is based on some information about the user contained in a user's profile. Often, this is implemented using collaborative filtering, which is a type of recommendation system technology commonly used in e-commerce systems. Collaborative filtering typically is implemented to analyze the user's past behavior in conjunction with the behavior of other users of a particular system. For example, ratings for products may be collected from all users to form a collaborative set of related interests, and a statistical comparison can be made between the user's personal set of ratings to the collaborative in order to formulate suggestions for the user.

### SUMMARY

A method includes monitoring user data generated by at least one client device used by a user. The method also includes, based on the user data, automatically determining at least one item that is of interest to the user. The method also includes tracking activities of the user and, based on tracking the activities of the user, automatically determining, using a processor, whether the user has free time available. The method also includes, responsive to determining that the user has free time available, presenting to the user, via the at least one client device, a notification, the notification indicating to the user the at least one item that is of interest to the user and the notification further providing actionable information related to the at least one item that is of interest to the user.

A system includes a processor programmed to initiate executable operations. The executable operations include monitoring user data generated by at least one client device used by a user. The executable operations also include, based on the user data, automatically determining at least one item that is of interest to the user. The executable operations also include tracking activities of user and, based on tracking the activities of the user, automatically determining, using a processor, whether the user has free time available. The executable operations also include, responsive to determining that the user has free time available, presenting to the user, via the at least one client device, a notification, the notification indicating to the user the at least one item that is of interest to the user and the notification further providing actionable information related to the at least one item that is of interest to the user.

A computer program includes a computer readable storage medium having program code stored thereon. The program code is executable by a processor to perform a method. The method includes monitoring, by the processor, user data generated by at least one client device used by a user. The method also includes, based on the user data, automatically determining, by the processor, at least one item that is of interest to the user. The method also includes tracking, by the processor, activities of user and, based on tracking the activities of the user, automatically determining, by the processor, whether the user has free time available. The method also includes, responsive to determining that the user has free time available, presenting, by the processor, to the user, via the at least one client device, a notification, the notification indicating to the user the at least one item that is of interest to the user and the notification further providing actionable information related to the at least one item that is of interest to the user.

### BRIEF DESCRIPTION OF THE DRAWINGS

FIG. 1 is a block diagram illustrating an example of a computing environment.

FIG. 2 is a flow chart illustrating an example of a method of learning user patterns.

FIG. 3 is a flow chart illustrating an example of a method of presenting to a user a notification indicating to the user the at least one item that is of interest to the user.

FIG. 4 is a block diagram illustrating example architecture for a server.

FIG. 5 is a block diagram illustrating example architecture for a client device.

### DETAILED DESCRIPTION

This disclosure relates to electronic communications, and more particularly, to communication of prompts to users regarding items that may be of interest to the users. In accordance with the inventive arrangements disclosed herein, user data generated by at least one client device used by a user can be monitored. The user data can include, for example, data representing the user's gestures and vocalizations. Based on the user data, at least one item that is of interest, or potentially of interest, to the user can be automatically identified. Further, activities of the user can be tracked. Based on such tracking, an automatic determination can be made whether the user has free time available. Responsive to determining that the user has free time available, a notification can be presented to the user indicating to the user the at least one item of interest and providing information related to that item. The notification can serve to prompt, or remind, the user to perform further research and/or actions regarding the item, for example by accessing content relating to the items via the Internet, visiting a store or showroom of a vendor of the item, attending a conference or event related to the item, etc.

Several definitions that apply throughout this document now will be presented.

As defined herein, the term “server” means a processing system, comprising at least one processor and memory, which hosts at least one application or service accessible by at least one client device.

As defined herein, the term “client device” means a device or system comprising at least one processor and memory used by a user. Examples of a client device include, but are not limited to, a workstation, a desktop computer, a mobile computer, a laptop computer, a netbook computer, a tablet computer, a smart phone, a digital personal assistant, a smart watch, smart glasses, a gaming device, a set-top box, and the like.

As defined herein, the term “item” means an object, topic or concern.

As defined herein, the term “free time” means a time when a user (i.e., a person) is not working. Free time for a user can be, for example, when the user is idle, walking or browsing the Internet.

As defined herein, the term “actionable information” means information that prompts a user to take at least one action related to at least one item that is of interest to the user.

As defined herein, the term “gesture” means a movement of a user's body, movement of one or more of a user's limbs, movement of one or more of a user's eyes, and/or movement of one or more of a user's facial muscles, such movement(s) expressing or emphasizing an idea, a sentiment, or an attitude.

As defined herein, the term “user vocalization” means audio information generated by a user's vocal cords and/or mouth, for example an utterance spoken by a user, a vocal sound made by the user (e.g., a sigh, whistle, etc.), or the like.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “output” means storing in memory elements, writing to display or other peripheral output device, sending or transmitting to another system, exporting, or the like.

As defined herein, the term “automatically” means without user intervention.

As defined herein, the term “user” means a person (i.e., a human being).

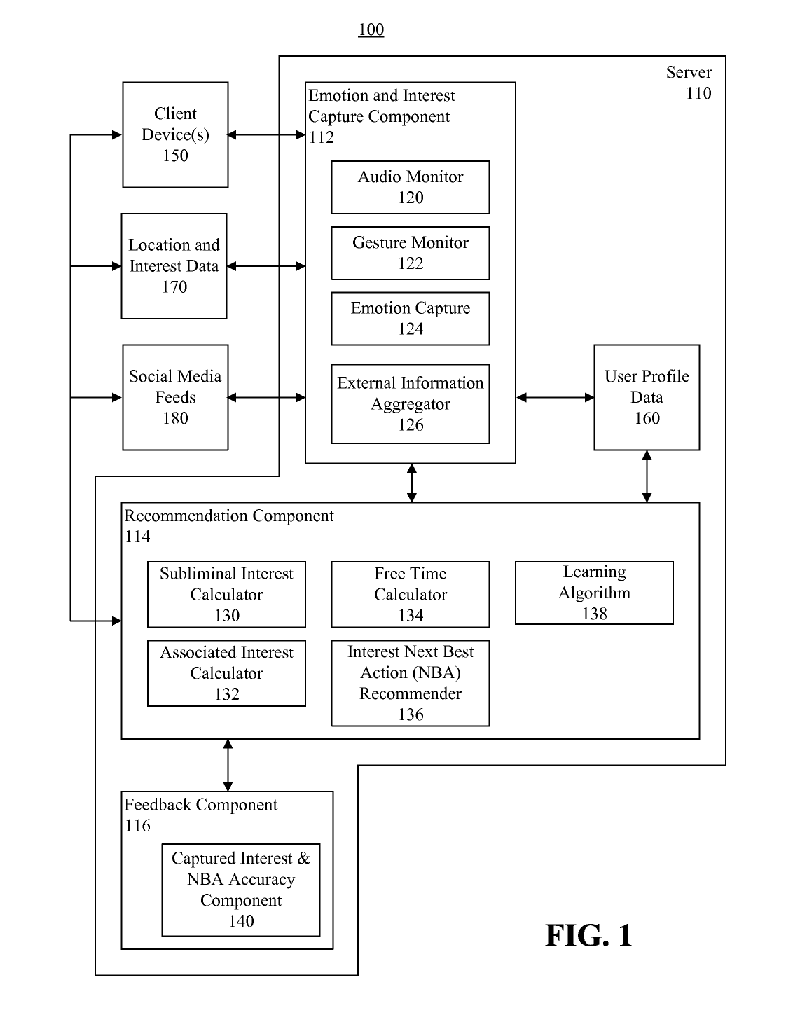

FIG. 1 is a block diagram illustrating an example of a computing environment 100. The computing environment can include at least one server 110 and one or more client devices 150. Optionally, the computing environment also can include location and interest data 170, for example location and interest data provided by a third party and accessible by the server 110. The computing environment also can include, optionally, social media feeds 180 accessible by the server 110 from one or more social media sites.

The server 110 can be communicatively linked to the client device(s) 150, the location and interest data 170, and the social media feeds 180 via one or more communication networks. A communication network is the medium used to provide communications links between various devices and processing systems connected together within the computing environment 100. The communication network may include connections, such as wire, wireless communication links, or fiber optic cables. The communication network can be implemented as, or include, any of a variety of different communication technologies such as a WAN, a LAN, a wireless network, a mobile network, a Virtual Private Network (VPN), the Internet, the Public Switched Telephone Network (PSTN), or the like.

The server 110 can execute an operating system and one or more applications. At least one of the applications can include an emotion and interest capture component 112, a recommendation component 114 and a feedback component 116. The emotion and interest capture component 112 can include an audio monitor 120, a gesture monitor 122, an emotion capture 124, and an external information aggregator 126. The emotion and interest capture component 112 also can include other components configured to monitor user emotion/interest (not shown).

The audio monitor 120 can monitor user audio data generated by the client device 150 responsive to the client device 150 detecting at least one user vocalization, for example utterances spoken by the user. The audio monitor 120 also can monitor other sounds generated by the user, for examples claps, taps, etc. indicted in the audio data. In illustration, a client device 150 can include an audio input transducer (e.g., microphone) that detects user vocalizations and other sounds generated by users. The client device 150 can perform analog to digital conversion of the user vocalizations and other sounds, and communicate, in real time, the digitized version of the user vocalizations and other sounds to the audio monitor 120 as user data. The audio monitor 120 can identify information contained in the user vocalizations and other sounds and store corresponding data in user profile data 160.

In one arrangement, to identify the information, the audio monitor 120 can implement natural language processing (NLP) and semantic analysis on the user vocalizations. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. In one optional arrangement, NLP and semantic analysis on user vocalizations and other sounds detected by a client device 150 can be implemented by the client device 150, and results of NLP and semantic analysis can be communicated from the client device 150 to the audio monitor 120.

The gesture monitor 122 can monitor user gesture data generated by the client device 150 responsive to the client device 150 detecting at least one gesture made by the user. In illustration, the client device 150 can include a camera that detects images and/or video of a user, and the client device 150 can communicate, in real time, image and/or video data to the gesture monitor 122 responsive to detecting at least one user gesture. The client device 150 also can monitor the user's Internet activity, and communicate information related to the Internet activity to the gesture monitor 122 as user data. The gesture monitor 122 can process the user data and store corresponding data in the user profile data 160.

By of example, the user data can include images and/or video, which the gesture monitor 122 can process to identify user gestures of a user, for example by identifying facial expressions of the user, movement of the user's eyes, movement of the user's hands and/or arms, or the like. Further, if the user gestures include the user touching or holding an item, the gesture monitor 122 can identify that item and a class of items to which the item belongs. Also, if the user navigates to a web page including information about an item or class of items, the gesture monitor 122 can identify such user navigation to identify the item or class of items. Detection of user gestures and items in this manner is known to those skilled in the art. In one optional arrangement, identification of the user gestures can be performed by the client device 150, and results of such identification can be communicated from the client device 150 to the gesture monitor 122.

The emotion capture 124 can, in real time, receive information generated by the audio monitor 120 relating to the user vocalizations and other sounds, and receive information generated by the gesture monitor 122 relating to the user gestures. The emotion capture 124 can process such information to determine emotions exhibited by the user with regard to items. For example, the emotion capture 124 can identify words or sounds vocalized by the user, voice inflections, claps or taps made by the user, gestures representing approval (e.g., a thumbs up gesture), gestures representing disapproval (e.g., a thumbs down gesture), and the like, and based on these vocalizations determine the user's emotions related to an item. The emotion capture 124 also can receive other information from the client device 150, such as metadata, user information, and the like.

The emotion capture 124 can aggregate such information by creating associations between the information received from the audio monitor 120, the gesture monitor 122 and directly from the client device 150, and determined emotions of the user. For example, if information received from the gesture monitor 122 indicates a user picking up an item, or browsing an item on the Internet, at a particular time, and the information received from the audio monitor 120 indicates that the user utters a vocalization representing an interest in the item at that particular time, the emotion capture 124 can associate the user gesture of the user picking up or viewing the item with the information relating to the user vocalization and the determined emotion. Thus, the emotion capture 124 can create association information indicating items that are of interest to the user. The associations can be created based on time stamps assigned to the various information received from the client device 150. The emotion capture 124 can store the aggregated information and the associations to user profile data 160 associated with the user and/or to another data storage location.

By way of example, if the user picks up an item, rotates the item, and gazes closely at the item for a significant amount of time (e.g., more than a threshold period of time), and perhaps utters words expressing interest in the item (e.g., “that is nice,” “I like this one,” etc.), the emotion capture 124 can process such user gestures and vocalizations to determine that there is a high level of interest in the item on the part of the user. If, however, the user picks up an item, and quickly puts the item back without gazing at the item for a significant amount of time, and perhaps says something indicating a moderate level of interest (e.g., “not sure if that is what I am looking for”) the emotion capture 124 can process such user gesture and vocalization to determine that there is a low level of interest in the item on the part of the user. If the user gazes at an item for a brief amount of time (e.g., less than a threshold period of time) without touching the item, and/or says something expressing apathy in the item (e.g., “that's not what I'm looking for”), the emotion capture 124 can process such user gesture and vocalization to determine that there is a no interest in the item on the part of the user.

It should be noted that the emotion capture 124 can access suitable algorithms known in the art to identify items based on captured visual images of the items or information related to items contained on a web page. For example, if images of a user holding an item are received from the client device 150, the emotion capture 124 can process such images to identify the item. In illustration, the emotion capture 124 can, based on one or more images of an item, generate parameters representing physical aspects of the item, and process such parameters to identify the item. In one aspect, the emotion capture 124 can search various images accessible via the Internet to identify other items having parameters similar to the generated parameters and, based on information associated with those images, identify such other items. For example, the emotion capture 124 can identify a type of item or a particular item (e.g., a camera or a specific camera model). Similarly, if the user is browsing information related to an item on a web page, the emotion capture 124 can process such information to identify the type of item or the particular item.

The external information aggregator 126 can collect various other data beyond audio and gestures generated by a user. For example, a client device 150 can be configured to monitor a user's heart rate. The client device 150 can communicate data corresponding to the user's heard rate to the external information aggregator 126. Similarly, a client device 150 can be configured to monitor a location, for example via a global positioning system (GPS) receiver, and communicate data corresponding to the user's location to the external information aggregator 126. The client device 150 also can communicate a user's calendar information to the external information aggregator 126, communicate data relating to the user's Internet browsing activity, etc. The external information aggregator 126 can store information gathered to the user profile data 160 associated with the user and/or to another data storage location.

The recommendation component 114 can include a subliminal interest calculator 130, a free time calculator 134, an associated interest calculator 132, an interest next best action (NBA) recommender 136 and a learning algorithm 138.

The subliminal interest calculator 130 can process information contained in a user's user profile data 160, and/or information stored to another data storage location by one or more components 120-126 of the emotion and interest capture component 112, to determine the user's level of interest in one or more items for which the user may not even be aware of such interest. In illustration, the emotion and interest capture component 112 can process audio corresponding to at least one vocalization of the user and gesture data corresponding to at least one physical gesture made by the user, as well as location and interest data 170 and data received over social media feeds 180, to identify such items. Responsive to identifying such items, the subliminal interest calculator 130 can update the user profile data 160 to include information indicating that the user may have an interest in the items, and the level of interest.

By way of example, a user may be looking at various houses for a prospective home purchase. While looking at certain houses, the user may utter statements such as “I like this kitchen,” “this kitchen is nice,” or the like. The subliminal interest calculator 130 can identify each house the user looks at based on GPS coordinates obtained from the client device 150 by the external information aggregator, and associate comments made by the user with the respective houses the user was looking at when the user made the comments. Further, the subliminal interest calculator 130 can access location and interest data 170 containing information about the houses. Based on NLP and semantic analysis applied to the detected spoken utterances, the subliminal interest calculator 130 can retrieve information for each house that relates to their respective kitchens. The subliminal interest calculator 130 can compare this information to identify features that are common to the kitchens the user indicated he/she liked, but may not be included in kitchens in which the user indicated dislike or indifference. For example, if the user provided positive utterances when viewing kitchens that have center islands with granite counter tops, but was indifferent to kitchens that did not have that feature, the subliminal interest calculator 130 can determine, or infer, that the user likes houses that have a center island with granite counter tops in the kitchen, and thus has a high level of interest in such items.

The associated interest calculator 132 can process information contained in a user's user profile data 160 to identify items that may be of tangential interest to the user, which may be used to help the user explore other topics. In illustration, the associated interest calculator 132 can access, via the Internet, various web-based resources, such as web pages and the like, to identify a category to which an item of interest belongs. Further, using the web-based resources, the associated interest calculator 132 can identify other items in that category. By way of example, if the user's profile data 160 indicates that the user is interested in web connected speakers, the associated interest calculator 132 can identify other types of web connected audio components, such as web connected receivers. Responsive to identifying such items, the associated interest calculator 132 can update the user profile data 160 to include information indicating that the user may have an interest in the items.

The free time calculator 134 can track activities of the user to determine whether the user has free time available and, if so, when. The free time can be presently available or available at some future time. In illustration, the free time calculator 134 can access various information obtained by the external information aggregator 126, and process such information to determine when the user has free time. For instance, the free time calculator 134 can process the user's calendar information to identify times when the user has no meetings or activities scheduled, process the user's GPS information do determine whether the user is at a place of employment, at home, or elsewhere, process the user's Internet browsing activity to determine whether the user is leisurely browsing the Internet, process the user's heart rate information to determine whether the user is exercising or relaxed, etc. Further, the free time calculator 134 can process the user's GPS information to determine whether the user is sitting still, moving at a walking pace, running, traveling in a vehicle on a road, or travelling via public transportation, for example in a train, a subway or an airliner. The free time calculator 134 also can process the user's audio and gesture information to determine whether the user is involved in conversation, exercising, etc., determine whether the user is relaxed or busy, and the like. Free time on the part of the user can be determined by the free time calculator 134 based on such determinations.

If, for example, the free time calculator 134 determines that the user is located at home, leisurely browsing the Internet or watching television (e.g., which can be indicated by the gesture monitor 122 identifying that the user's eyes are fixed for a threshold period of time), has a low heart rate, is not involved in conversation, and does not have a presently scheduled meeting or activity, the free time calculator 134 can determine that the user has free time. Similarly, if the free time calculator 134 determines that the user is walking at a leisurely pace, has a low heart rate, and is not involved in conversation, the free time calculator 134 can determine that the user has free time. Also, if the free time calculator 134 determines that the user is located on a moving train, has a low heart rate, and is not involved in conversation, the free time calculator 134 can determine that the user has free time. In yet another example, if user preferences or calendar indicate that the user takes lunch from 12:00 PM to 1:00 PM, and the free time calculator 134 determines that the user is sitting still in his/her place of employment with a low heat rate, the free time calculator 134 can determine that the user has free time.

The free time calculator 134 also can determine that the user will have free time sometime in the future, for example by processing information contained in the user's calendar, processing user profile data 160 which indicates when the user has days off from work, or processing user profile data 160 which indicates, based on user history, when the user typically has free time. Still, the free time calculator 134 can determine whether the user has free time in any other suitable manner, and the present arrangements are not limited in this regard.

Responsive to the free time calculator 134 determining that the user has free time available, the interest NBA recommender 136 can access the user profile data 160 to retrieve information generated by the emotion capture 124, the subliminal interest calculator 130 and the associated interest calculator 132 to select an item identified as being of interest of the user and/or an item in which the user may have an interest. The interest NBA recommender 136 can process the information to understand whether a captured interest, subliminal interest and/or associated interest is relevant to the user and the next best action to take based on such understanding. Through repeated interactions with the client device 150 and other components of the server 110, the interest NBA recommender 136 can build on the user profile data 160 to customize recommendations to be made to the user regarding various interests. For example, initially the interest NBA recommender 136 may determine that the user is interested in an item and may recommend a trip into a local retailer that sells the item.

By way of example, a plurality of interest items may be indicated in the user profile data 160, and the interest NBA recommender 136 can select one or more of the items identified as being of interest, or potentially being of interest, to the user. An item that is selected can be an item most recently identified as being of interest to the user, an item that is most often identified as being of interest to the user, an item that is most appropriate for the user based on contextual information associated with the user, and/or the like. For example, if there is a list of three items in order of importance and present contextual information related to the user indicates the user has free time, the first item can be shown first to the user. If, however, the present contextual information related to the user indicates the third item is presently is more relevant to the user, (e.g., the user has free time and is located in a park where the third item can be explored), then the NBA recommender 136 can prompt the user to take action with regard to the third item.

Further, the interest NBA recommender 136 can access location and interest data 170 provided by third parties, as well as social media feeds 180, and identify various information and events related to the selected item. For example, if the selected item of interest to the user is a camera, the interest NBA recommender 136 can identify reviews pertaining to cameras, or a particular camera, for which the user may have expressed interest. The interest NBA recommender 136 also can identify related events, such as conferences, demonstrations, etc. that relate to the user's interest, or the user's potential interest, that are scheduled to take place. In one aspect, the interest NBA recommender 136 can filter information related to such events to limit the information to events taking place within a particular distance from the user's home or place of work, limit the information to events taking place when the user does not have other commitments scheduled in the user's calendar, or limit the information based on user preferences indicted in the user profile data 160.

In another example, if the subliminal interest calculator 130 has determined that the user is interested in homes with particular features, the interest NBA recommender 136 can access location and interest data 170, or other information accessible via the Internet related to homes, to identify homes which have those features and which are located in a geographic region where the user has been looking at homes. In yet another example, if the user profile data 160 indicates that the user is interested in a particular item, or type of item, and the user's GPS information indicates that the user presently is located near a business (e.g., vendor) or other entity that provides information related to the item of interest to the user, or other items related to the item that is of interest to the user, the interest NBA recommender 136 can identify that business or entity and the business or entity's physical location (e.g., a location of a store or showroom carrying the item of interest, a park where an event related to the item of interest is taking place, etc.). The interest NBA recommender 136 can identify the business or other entity by processing location and interest data 170 associated with that business or entity, which the interest NBA recommender 136 may retrieve via the Internet. At this point it should be noted that the present arrangements are not limited to these examples, and any other information related to user interests and/or potential user interests can be identified and/or determined by the interest NBA recommender 136.

Based on interest information identified and/or determined by the interest NBA recommender 136, and responsive to the free time calculator 134 determining the user has free time, either presently or sometime in the future, the interest NBA recommender 136 can present to the user a notification indicating to the user the at least one item that is of interest to the user, or at least one item that potentially is of interest to the user, providing information gathered by the interest NBA recommender 136 related to the at least one item that is of interest to the user, and providing actionable information related to that item. In illustration, the interest NBA recommender 136 can communicate an electronic message (e.g., an e-mail, text message, instant message, or the like) from the server 110 to the user, for instance to at least one client device 150 used by the user. The notification can, for example, indicate item(s) of interest or of potential interest to the user, indicate information pertaining to the item(s) (e.g., prices, reviews, specifications, comparisons, events, etc.), provide hyperlinks to web-based resources (e.g., web pages) containing information pertaining to the item(s) that is/are of interest to the user, indicate one or more vendors of such item(s) and their respective locations, etc. In this regard, the notification can serve to prompt, or remind, the user to perform further research and/or actions regarding the item of interest in his/her free time.

By way of example, the notification can include text that states “It looks like you may have some free time available. You may be interested in exploring information about cameras. The table below is a comparison of some cameras you may be interested in. Also, you may select the hyperlinks below to further explore this subject.” In another example, based on GPS information received from the client device 150, the interest NBA recommender 136 can determine a present geographic location of the user, and determine whether the user's present geographic location is within a threshold distance from a store or showroom that has an item that is of interest to the user, or has items related to the item that is of interest to the user. Responsive to determining that the user's present geographic location is within the threshold distance, the notification generated by the interest NBA recommender 136 can prompt the user to visit the store or showroom and indicate the geographic location of the store or showroom, for example by providing an address of the store or showroom or providing a map that gives directions to the store or showroom from the user's present geographic location.

Further, the interest NBA recommender 136 can process additional information from the feedback components 116 to supplement insights used to provide recommendations. The feedback component 116 can include a captured interest and NBA accuracy component (hereinafter “accuracy component”) 140 configured to monitor the user's actions after receiving notifications. The feedback component 116 can communicate such information to the interest NBA recommender 136, which can process that information to customize other notifications communicated to the user. For example, the accuracy can determine that suggestions to travel to a local retailer often are ignored, but recommendations to specific reviews online are more effective in persuading the user to perform further research regarding the user's interest(s). Accordingly, the interest NBA recommender 136 can learn from this information to put more emphasis on reviews in further notifications communicated to the user. The interest NBA recommender 136 can utilize the learning algorithm 138 to learn the user's patterns and customize the notifications accordingly.

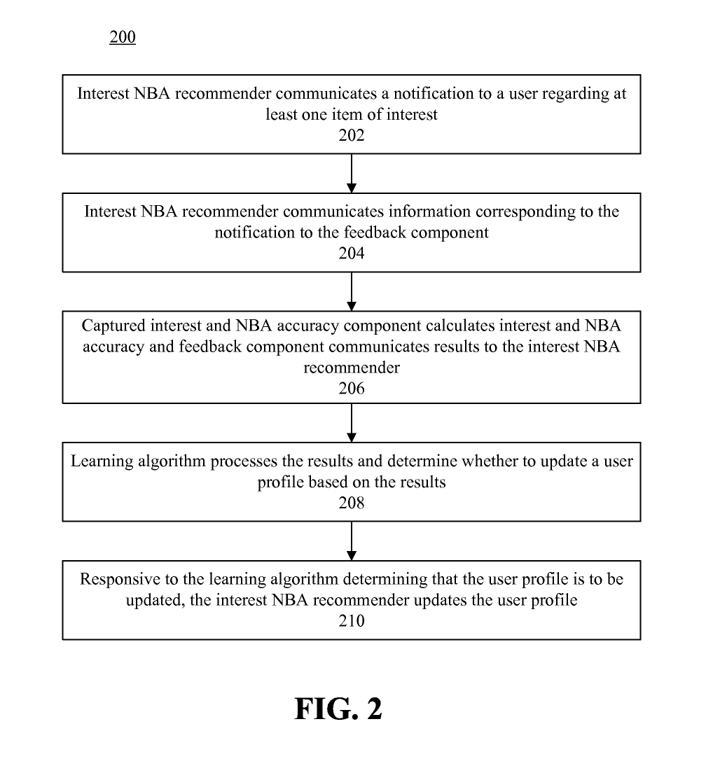

FIG. 2 is a flow chart illustrating an example of a method 200 of learning user patterns. At step 202, the interest NBA recommender 136 can communicate a notification to a user regarding at least one item of interest. At step 204, the interest NBA recommender 136 can communicate information corresponding to the notification to the feedback component 116. At step 206, the accuracy component 140 can calculate interest and NBA accuracy by identifying recommendations indicated in the notification, monitoring/identifying actions taken by the user responsive to, or after, the user receiving the notification, and determining whether the user's actions correspond to one or more recommendations contained in the notification. The feedback component 116 can communicate the results of such determination to the interest NBA recommender 136. The interest NBA recommender 136 can initiate the learning algorithm 138 to process the results and determine whether to update the user's profile data 160 based on the results. For example, if the results are clear that the user did not follow the recommendation or did follow the recommendation, a determination can be made to update the user's profile data 160. If the results are not clear, for example there is insufficient data to make a clear determination, a determination can be made not to update the user's profile data 160. At step 210, responsive to the learning algorithm 138 determining that the user profile data 160 is to be updated, the interest NBA recommender 136 can update the user profile data 160 based on the results.

For example, if the user did not follow a recommendation to visit a local retailer after such suggestion was made, the user profile data 160 can be updated to indicate that such a recommendation is to be given low priority. On the other hand, if the user followed a recommendation to access reviews online, the user profile data 160 can be updated to indicate that such a recommendation is to be given high priority. When generating notifications, the interest NBA recommender 136 can evaluate the priority assigned to various types of recommendations for that user, and select to include in notifications to the user those types of recommendations having high priority. Recommendations having low priority optionally can be included in notifications, but can be given less emphasis than high priority recommendations.

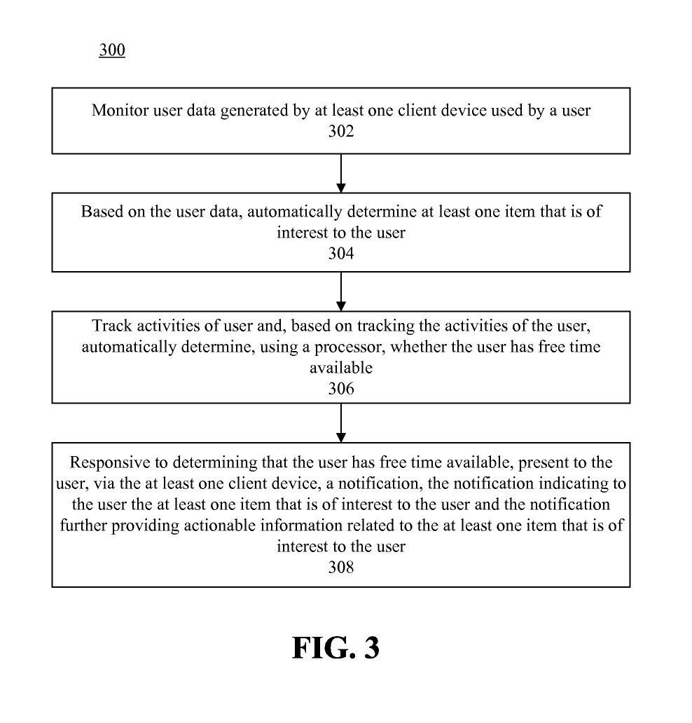

FIG. 3 is a flow chart illustrating an example of a method 300 of presenting to a user a notification indicating to the user the at least one item that is of interest to the user. At step 302, user data generated by at least one client device used by a user can be monitored. For example, user gesture and audio data generated by the client device can be monitored. At step 304, based on the user data, at least one item that is of interest to the user can be automatically determined. At step 306, activities of the user can be tracked. Based on tracking the activities of the user, whether the user has fee time available can be automatically determined using a processor. At step 308, responsive to determining that the user has free time available, a notification can be presented to the user via the at least one client device. The notification can indicate to the user the at least one item that is of interest to the user and the notification can further provide actionable information related to the at least one item that is of interest to the user.

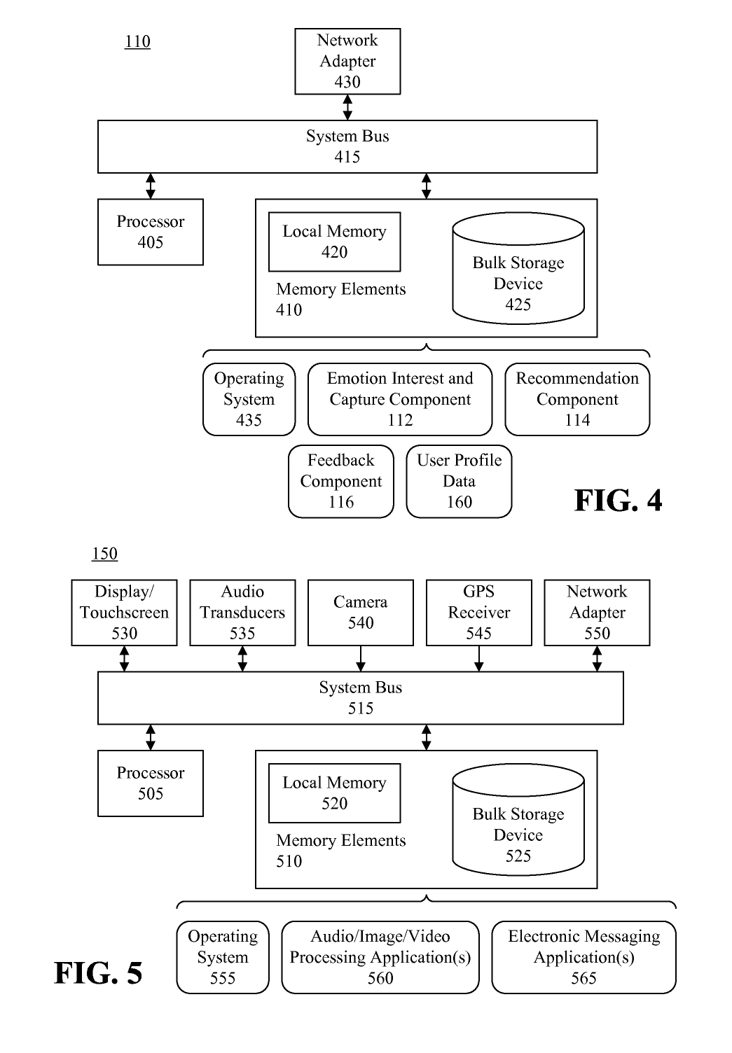

FIG. 4 is a block diagram illustrating example architecture for a server 110, such as the server 110 of FIG. 1. The server 110 can include at least one processor 405 (e.g., a central processing unit) coupled to memory elements 410 through a system bus 415 or other suitable circuitry. As such, the server 110 can store program code within the memory elements 410. The processor 405 can execute the program code accessed from the memory elements 410 via the system bus 415. It should be appreciated that the server 110 can be implemented in the form of any system including a processor and memory that is capable of performing the functions and/or operations described within this specification as being performed by the server 110.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), or other persistent data storage device. The server 110 also can include one or more cache memories (not shown) that provide temporary storage of at least some program code in order to reduce the number of times program code must be retrieved from the bulk storage device 425 during execution.

One or more network adapters 430 can be coupled to server 110 via the system bus 415 to enable the server 110 to become coupled to other systems, computer systems, remote printers, and/or remote storage devices through intervening private or public networks. Modems, cable modems, transceivers, and Ethernet cards are examples of different types of network adapters 430 that can be used with the server 110.

As pictured in FIG. 4, the memory elements 410 can store the components of the server 110, namely an operating system 435, the emotion and interest capture component 112, the recommendation component 114 and the feedback component 116. Being implemented in the form of executable program code, these components of the server 110 can be executed by the server 110 and, as such, can be considered part of the server 110. Further, the server 110 can store the user profile data 160. The operating system 435, emotion and interest capture component 112, recommendation component 114, feedback component 116 and user profile data 160 are functional data structures that impart functionality when employed as part of the server 110.

FIG. 5 is a block diagram illustrating example architecture for a client device 150, such as the client device 150 of FIG. 1. The client device 150 can include at least one processor 405 (e.g., a central processing unit) coupled to memory elements 510 through a system bus 515 or other suitable circuitry. As such, the client device 150 can store program code within the memory elements 510. The processor 505 can execute the program code accessed from the memory elements 510 via the system bus 515. It should be appreciated that the client device 150 can be implemented in the form of any system including a processor and memory that is capable of performing the functions and/or operations described within this specification. For example, the client device 150 can be implemented as a workstation, a desktop computer, a mobile computer, a laptop computer, a netbook computer, a tablet computer, a smart phone, a digital personal assistant, a smart watch, smart glasses, a gaming device, a set-top box, and the like.

The memory elements 510 can include one or more physical memory devices such as, for example, local memory 520 and one or more bulk storage devices 525. Local memory 520 refers to RAM or other non-persistent memory device(s) generally used during actual execution of the program code. The bulk storage device(s) 525 can be implemented as a HDD, SSD, or other persistent data storage device. The client device 150 also can include one or more cache memories (not shown) that provide temporary storage of at least some program code in order to reduce the number of times program code must be retrieved from the bulk storage device 525 during execution.

Input/output (I/O) devices such as a display and/or touchscreen 530, input and output audio transducers 535, one or more cameras 540 and a GPS receiver 545 can be coupled to the client device 150. One or more pointing devices (not shown) also can be coupled to the client device 150. The I/O devices can be coupled to the client device 150 either directly or through intervening I/O controllers. For example, the display/touchscreen 530 can be coupled to the client device 150 via a graphics processing unit (GPU), which may be a component of the processor 505 or a discrete device. One or more network adapters 550 also can be coupled to client device 150 to enable the client device 150 to become coupled to other systems, computer systems, remote printers, and/or remote storage devices through intervening private or public networks.

As pictured in FIG. 5, the memory elements 510 can store the components of the client device 150, namely an operating system 555, one or more audio/image/video processing applications 560 and one or more electronic messaging applications 565, for example a text message client, an instant message client, an e-mail client and/or a another client application configured to receive and present notifications received from the server 110. Being implemented in the form of executable program code, these components of the client device 150 can be executed by the client device 150 and, as such, can be considered part of the client device 150. Moreover, the operating system 555, audio/image/video processing application(s) 560 and electronic messaging application(s) 565 are functional data structures that impart functionality when employed as part of the client device 150 of FIG. 5.

The audio/image/video processing application(s) 560 can be configured to receive data audio, image and video data captured by an input audio transducer 535 and the camera 540, process such data to generate user data, and communicate the user data to the server 110. The operating system can communicate GPS data generated by the GPS receiver 545 to the server 110. The electronic messaging application(s) 565 can be configured to receive from the server 110 the previously described notifications, and present the notifications on the display/touchscreen 530. Optionally, the electronic messaging application(s) 565 can be configured to audibly present the notifications via an output audio transducer 535.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
monitoring user data generated by at least one client device used by a user;
based on the user data, automatically determining at least one item that is of interest to the user;
tracking activities of user and, based on tracking the activities of the user, automatically determining, using a processor, whether the user has free time available; and
responsive to determining that the user has free time available, presenting to the user, via the at least one client device, a notification, the notification indicating to the user the at least one item that is of interest to the user and the notification further providing actionable information related to the at least one item that is of interest to the user.

2. The method of claim 1, wherein monitoring the user data generated by the at least one client device used by the user comprises:
monitoring user gesture data generated by the at least one client device responsive to the client device detecting at least one gesture made by the user.

3. The method of claim 1, wherein monitoring the user data generated by the at least one client device used by the user comprises:
monitoring user audio data generated by the at least one client device responsive to the client device detecting at least one user vocalization.

4. The method of claim 1, wherein providing actionable information related to the at least one item that is of interest to the user comprises:
providing a link to at least one web-based resource that includes the information related to the at least one item that is of interest to the user.

5. The method of claim 1, further comprising:
determining a present geographic location of the user;
wherein:
presenting to the user the notification further is responsive to determining that that the present geographic location of the user is within a threshold distance from at least one physical business or entity that provides further information related to the item that is of interest to the user or items related to the item that is of interest to the user; and
the notification indicates a geographic location of the physical business or entity.

6. The method of claim 1, further comprising:
monitoring at least one action taken by the user responsive to the user receiving the notification;
determining whether the at least one action corresponds to at least one recommendation contained in the notification; and
responsive to determining whether the at least one action corresponds to at least one recommendation contained in the notification, updating user profile data of the user with results of the determination.

7. The method of claim 1, wherein the user data comprises gesture data corresponding to at least one physical gesture made by the user and audio data corresponding to at least one vocalization of the user, the method further comprising:
determining a level of interest in the at least one item by processing the gesture data and audio data, wherein the user is not aware that the user is interested in the at least one item.

8. A system comprising:
a processor programmed to initiate executable operations comprising:
monitoring user data generated by at least one client device used by a user;
based on the user data, automatically determining at least one item that is of interest to the user;
tracking activities of user and, based on tracking the activities of the user, automatically determining, using a processor, whether the user has free time available; and
responsive to determining that the user has free time available, presenting to the user, via the at least one client device, a notification, the notification indicating to the user the at least one item that is of interest to the user and the notification further providing actionable information related to the at least one item that is of interest to the user.

9. The system of claim 8, wherein monitoring the user data generated by the at least one client device used by the user comprises:
monitoring user gesture data generated by the at least one client device responsive to the client device detecting at least one gesture made by the user.

10. The system of claim 8, wherein monitoring the user data generated by the at least one client device used by the user comprises:
monitoring user audio data generated by the at least one client device responsive to the client device detecting at least one user vocalization.

11. The system of claim 8, wherein providing actionable information related to the at least one item that is of interest to the user comprises:
providing a link to at least one web-based resource that includes the information related to the at least one item that is of interest to the user.

12. The system of claim 8, the executable operations further comprising:
determining a present geographic location of the user;
wherein:
presenting to the user the notification further is responsive to determining that that the present geographic location of the user is within a threshold distance from at least one physical business or entity that provides further information related to the item that is of interest to the user or items related to the item that is of interest to the user; and
the notification indicates a geographic location of the physical business or entity.

13. The system of claim 8, the executable operations further comprising:
monitoring at least one action taken by the user responsive to the user receiving the notification;
determining whether the at least one action corresponds to at least one recommendation contained in the notification; and
responsive to determining whether the at least one action corresponds to at least one recommendation contained in the notification, updating user profile data of the user with results of the determination.

14. The system of claim 8, wherein the user data comprises gesture data corresponding to at least one physical gesture made by the user and audio data corresponding to at least one vocalization of the user, the executable operations further comprising:
determining a level of interest in the at least one item by processing the gesture data and audio data, wherein the user is not aware that the user is interested in the at least one item.

15. A computer program product comprising a computer readable storage medium having program code stored thereon, the program code executable by a processor to perform a method comprising:
monitoring, by the processor, user data generated by at least one client device used by a user;
based on the user data, automatically determining, by the processor, at least one item that is of interest to the user;
tracking, by the processor, activities of user and, based on tracking the activities of the user, automatically determining, by the processor, whether the user has free time available; and
responsive to determining that the user has free time available, presenting, by the processor, to the user, via the at least one client device, a notification, the notification indicating to the user the at least one item that is of interest to the user and the notification further providing actionable information related to the at least one item that is of interest to the user.

16. The computer program product of claim 15, wherein monitoring the user data generated by the at least one client device used by the user comprises:
monitoring user gesture data generated by the at least one client device responsive to the client device detecting at least one gesture made by the user.

17. The computer program product of claim 15, wherein monitoring the user data generated by the at least one client device used by the user comprises:
monitoring user audio data generated by the at least one client device responsive to the client device detecting at least one user vocalization.

18. The computer program product of claim 15, wherein providing actionable information related to the at least one item that is of interest to the user comprises:
providing a link to at least one web-based resource that includes the information related to the at least one item that is of interest to the user.

19. The computer program product of claim 15, the method further comprising:
determining a present geographic location of the user;
wherein:
presenting to the user the notification further is responsive to determining that that the present geographic location of the user is within a threshold distance from at least one physical business or entity that provides further information related to the item that is of interest to the user or items related to the item that is of interest to the user; and
the notification indicates a geographic location of the physical business or entity.

20. The computer program product of claim 15, the method further comprising:
monitoring at least one action taken by the user responsive to the user receiving the notification;
determining whether the at least one action corresponds to at least one recommendation contained in the notification; and
responsive to determining whether the at least one action corresponds to at least one recommendation contained in the notification, updating user profile data of the user with results of the determination.
